(19) United States
(12) Patent Application Publication
(10) Pub. No.: US 2008/0314407 A1
(43) Pub. Date: Dec. 25, 2008

(54) Method of Cleaning an Optical Face of a Refractive Element for a Near Field Optical Scanning Apparatus and a Cleaning Device for Cleaning an Optical Face of a Refractive Element for a Near Field Optical Scanning Apparatus

(75) Inventors: Dominique Maria Bruls, Eindhoven (NL); Jacobus Maria Antonius Van Den Eerenbeemd, Eindhoven (NL); Franciscus Marinus Andrea Maria Van Gaal, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,557

(22) PCT Filed: Dec. 6, 2006
(86) PCT No.: PCT/IB06/54636

§ 371 Date: Jun. 16, 2008

(30) Foreign Application Priority Data
Dec. 16, 2005 (EP) 05112295.0

(51) Int. Cl. B08B 1/00; B08B 13/00

(52) U.S. Cl. 134/1; 15/250.001; 15/250.22

(57) ABSTRACT

The invention provides a method and a device for cleaning of the optical face of a refractive element for a near field optical scanning apparatus. A magnetically susceptible cleaning material is used to facilitate effective cleaning of the refractive element without damage to the element. The method according to the invention can be combined with known cleaning methods if desired.

### FIELD OF THE INVENTION

The invention relates to the field of optical recording devices of the near field type. Such devices are an evolution of current optical systems towards the ability to store greater amounts of data on an optical record carrier and to facilitate retrieval of densely packed data on such an optical record carrier. In particular, the invention relates to a method of cleaning an optical face of a refractive element of a near field optical scanning apparatus for scanning an optical record carrier. The invention also relates to a cleaning device suitable for cleaning an optical face of a refractive element of a near field optical scanning apparatus for scanning an optical record carrier.

### BACKGROUND OF THE INVENTION

An optical scanning device utilizes light to read information from, or write information to, an optical record carrier. Scanning in this context comprises the read and write modes in which data is transferred from, and to, the optical record carrier. In near field optical recording light is directed towards the optical record carrier by the optics of the device comprising a refractive element, often a solid immersion lens (SIL).

The effective numerical aperture (NA) of the optics of near field devices is generally larger than unity and, for those devices comprising a SIL lens, it is larger than unity due to the higher refractive index of the refractive element in comparison with air. The higher NA facilitates a denser data placement, due to the increase in resolving power of the optical system, which in turn increases the data storage capacity of the system. The depth of focus of the system and the required air gap (i.e. the distance between the SIL and the surface of the optical record carrier during normal operation) between the refractive element and the optical medium on the record carrier is, however, consequently reduced. For a typical near field system the air gap has a range of 20 to 30 nm. The air gap is maintained at desired levels in the apparatus by active servo control. This often comprises use of a gap error signal, derived from light passing through the refractive element. Servo control helps to compensate for issues such as unflatness of the optical record carrier, disc irregularities, tilts, and axial run-out of disc and motor.

The optical record carrier comprises various layers of material arranged in a stack formation, at least one layer of which is designed to store data. Often a cover layer protects the data layer from damage and contamination.

A more complete description of a near field system can be found in the Proceedings of SPIE (Optical Data Storage 2004), ed. B. V. K. Vijaya Kumar, Vol. 5380, pp 209-223.

A problem with such a near field optical system is that contamination of the refractive element deteriorates the functioning of the system, hindering correct and reliable operation.

### SUMMARY OF THE INVENTION

It is an object of the invention to improve the performance of the near field optical scanning apparatus, specifically the performance of the refractive element.

This object is realized by provision of a method of cleaning an optical face of a refractive element for a near field optical scanning apparatus for scanning an optical record carrier, the method comprising steps of:
A first cleaning step of bringing a magnetically susceptible cleaning material into mechanical contact with the optical face of the refractive element.

Extreme circumstances, such as a sudden external shock, a defect in the optical medium, a sudden failure of the servo system etc., can result in collision between refractive element and optical record carrier. A collision is likely to cause deposition of material on the refractive element. In addition, through normal use, it is possible for debris or dust to be accumulated on the refractive element. Conically shaped SIL tips are particularly sharp and, in the event of a collision, exert more force on the optical record carrier and are more likely therefore to pickup debris.

The refractive element is made from material, which is usually harder than the optical medium. So the actual element itself does not sustain damage but rather picks up contamination. The contamination hampers the functioning of the read and write processes. An optical record carrier comprising a cover layer can generate contamination of a different type to an optical record carrier without a cover layer. The latter generates materials such as SiₓNₓ and Al, which are known to be particularly difficult to remove from glass surfaces. In some instances the refractive element may not physically be able to approach the optical record carrier to the required small gap distances, mentioned above, due to particulates present on the element. In other cases it may be that the gap error signal cannot be properly generated.

A cleaning material which is magnetically susceptible is effective in removing contamination from the refractive element. Mechanical contact may be all that is required depending on the type and level of contamination. The contamination is transferred to the magnetically susceptible material and leaves the refractive element clean. This restores the ability of the refractive element to transmit and direct light in the directions designed for optimum operation of the near field optical apparatus. In the best cases the refractive element performance can be restored to almost “as new”. The lack of abrasion of the cleaning material leaves no damage, such as scratches or marks, to the refractive element after cleaning. Conventionally difficult to remove materials, such as SiₓNₓ and Al, are also very easy to remove using such a cleaning material.

In a further embodiment of the invention, the cleaning material is magnetic. Magnetic materials are a sub group of magnetically susceptible materials but are permanently magnetized. Such materials are capable of removing the contamination from the refractive element. These materials are also useful in removing traces of other cleaning materials from the refractive element e.g. after cleaning with a metallic foil.

In a further embodiment of the invention, the cleaning material comprises a floppy disc foil. This type of foil is typically a flexible foil containing a sputtered magnetic layer. It is used in floppy disc cartridges as the recording medium. Other types of material which fall into the same category and which may also be used as cleaning materials include magnetic video tape, magnetic audio tape, magnetic pc tape etc.

In a further embodiment of the invention, the floppy disc foil comprises a pattern of recording tracks. The patterning of the foil improves the efficiency of the cleaning process. Other types of material as mentioned above, may also be patterned. For example, magnetic tape may also have a pattern. It is also possible that the pattern comprises embossed structures or microstructures of a design other than recording tracks, depending on the type of material being used.

In a further embodiment of the invention, a method of cleaning is provided comprising a further step of:
A second cleaning step of moving the cleaning material and the optical face of the refractive element relative to each other.

Regardless of whether the cleaning material is moved, or the refractive element is moved, or combined movement involves both elements being moved simultaneously, the additional forces generated by the movement assist in the cleaning of the refractive element. As the cleaning material is non-abrasive, the movement does not result in damage to the refractive element.

In a further embodiment of the invention, the floppy disc foil comprises a pattern of recording tracks. As described above, the patterning assists in the cleaning process.

In a further embodiment of the invention, a method of cleaning is provided further comprising the step of:
Moving the cleaning material and the optical face of the refractive element relative to each other, such that the optical face of the refractive element is drawn across the pattern of recording tracks.

In a further embodiment of the invention, a method of cleaning is provided further comprising the step of:
Moving the cleaning material and the optical face of the refractive element relative to each other, across the pattern of recording tracks, such that the optical face of the refractive element is alternately in contact with a section of floppy disc foil comprising a recording track and a section of floppy disc foil without a recording track.

For a floppy disc foil with a pattern of recording tracks, drawing the refractive element across the tracks makes the cleaning method more effective. The movement may be in any direction relative to a plurality of tracks, but can include motion back and forth over a single track. The least effective movement is along a track (essentially in the recording or reading direction) and the most effective movement is across the tracks (i.e. radially with respect to the floppy disc). When the refractive element encounters sections of disc which are alternately patterned with and without a recording track, the topography seen by the refractive element is increased and this also increases the efficiency of the cleaning method. Different pattern structures also affect the efficiency of the cleaning method.

In a further embodiment of the invention, a method of cleaning an optical face of a refractive element of a near field optical scanning apparatus is provided comprising a further step of:
A third cleaning step of moving a conventional cleaning substance and the optical face of the refractive element relative to each other.

Conventional cleaning substances comprise liquids, cleaning cloths, woven materials, pads etc. These methods are not sufficient to clean the refractive element by themselves but can be helpful in removing final traces of the cleaning material (e.g. floppy disc foil particulates) if any residues are present on the refractive element, after cleaning according to the method specified in the invention, once the main contamination has been removed.

In a further embodiment of the invention, there is provided a cleaning device suitable for cleaning an optical face for a refractive element of a near field optical scanning apparatus for scanning an optical record carrier, the cleaning device comprising a cleaning material characterized in that the cleaning material is magnetically susceptible.

A cleaning material which is magnetically susceptible is effective in removing contamination from the refractive element. Mechanical contact may be all that is required depending on the type and level of contamination. The contamination is transferred to the magnetically susceptible material and leaves the refractive element clean. This restores the ability of the refractive element to transmit and direct light in the directions deigned for optimum operation of the near field optical apparatus. In the best cases the refractive element performance can be restored to almost “as new”. The lack of abrasion of the cleaning material leaves no damage, such as scratches or marks, to the refractive element after cleaning. Conventionally difficult to remove materials, such as SiₓNₓ and Al, are also very easy to remove using such a cleaning material.

In a further embodiment of the invention, the cleaning device comprises a cleaning material which is magnetic.

Magnetic materials are a sub group of magnetically susceptible materials but are permanently magnetized. Such materials are capable of removing the contamination from the refractive element. These materials are also useful in removing traces of other cleaning materials from the refractive element e.g. after cleaning with a metallic foil.

In a further embodiment of the invention, the cleaning device comprises a cleaning material which comprises a floppy disc foil.

This type of foil is typically a flexible foil containing a sputtered magnetic layer. It is used in floppy disc cartridges as the recording medium. Other types of material which fall into the same category and which may also be used as cleaning materials include magnetic video tape, magnetic audio tape, magnetic pc tape etc.

In a further embodiment of the invention, the cleaning device comprises a cleaning material which comprises floppy disc foil comprising a pattern of recording tracks.

The patterning of the foil improves the efficiency of the cleaning process. Other types of material as mentioned above, may also be patterned. For example, magnetic tape may also have a pattern. It is also possible that the pattern comprises embossed structures or microstructures of a design other than recording tracks, depending on the type of material being used.

In a further embodiment of the invention, the cleaning device comprises a cleaning material which is mounted on a flexible carrier.

The cleaning material can be formed from a thin sheet or layer of e.g. magnetic foil. To support and strengthen this foil a carrier can be provided. This carrier is flexible in order to prevent damage to the refractive element and to increase the efficiency of the cleaning method by allowing the cleaning material to mould to the shape of the refractive element.

In a further embodiment of the invention, the cleaning device further comprises a cleaning tape, at least one section of which comprises the cleaning material.

A cleaning tape is a good example of how a flexible carrier can be utilized to bring the cleaning material into contact with the refractive element. One section of the tape comprises the cleaning material which cleans the refractive element. It is possible to have more than one section of tape, with different sections comprising different cleaning materials. The extended method of cleaning according to the invention, comprising contact of refractive element against the cleaning material, relative movement between the refractive element and the cleaning material, and then polishing away of residual particulates by a conventional cleaning cloth, could all be achieved in one process by placing the different materials on different sections of tape.

The cleaning material can also be mounted on a section of the optical record carrier or on part of the near field device to which the refractive element can be brought or on the disc cartridge.

### BRIEF DESCRIPTION OF THE DRAWINGS

The invention will now be further elucidated by reference to the drawings:

FIG. 1 (parts A and B) shows graphical representation of the gap error signal (GES) as a function of time, while the SIL is brought into contact with the optical record carrier and is retracted afterwards. The gap error signal, which is conventionally used to determine the distance between the refractive element of the near field apparatus and the optical record carrier, is shown generated through a clean SIL or refractive element (part A) and a dirty SIL (Part B). Thus the GES may be used to determine the cleanliness of the refractive element of the near field system.

FIG. 2 illustrates a method of cleaning an optical face of a refractive element of a near field optical scanning apparatus according to one possible embodiment of the invention.

FIG. 3 (parts A, B, C and D) illustrates a cleaning cassette comprising a cleaning tape according to the invention.

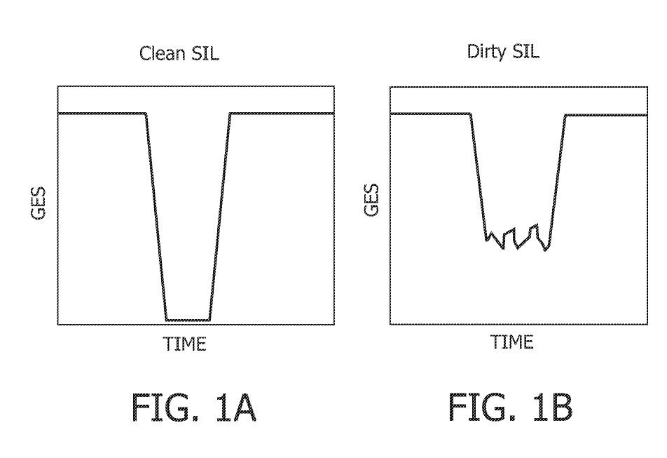

FIG. 1 illustrates two GES signals as a function of time, while the SIL is brought into contact with the optical record carrier and is retracted afterwards, one for a clean SIL tip (FIG. 1A) and one for a dirty SIL tip (FIG. 1B). The refractive element of a near field recording apparatus is here represented by a solid immersion lens (SIL) for the purposes of illustrative description of the invention. The GES is used to determine the distance between the SIL of the near field apparatus and the optical record carrier in such a system. The GES also travels through the part of the SIL through which the main light beam passes and is focused onto the optical record carrier. In addition, light information diffracted from the optical record carrier and the GES, returns to the near field system for detection and processing via the SIL. Thus the GES can be used to determine the cleanliness of the SIL, especially the SIL tip, as the transmission of light by the tip is affected by contamination. During operation a normalized GES is often used. If the GES at a far field position deviates from nominal, this is an indication that the SIL needs to be cleaned.

To check the SIL tip surface for the presence of contaminants, the SIL is pressed gently against the surface of the optical record carrier medium or another surface, such as a cleaning foil. If the tip is clean the GES will drop almost to zero (FIG. 1A). If the SIL is not clean, the GES will stay high and in some cases may exhibit oscillatory behavior (FIG. 1B). Checking of the SIL tip can take place, for example, at start-up, when a new disc is loaded, or after a shock or SIL-carrier collision.

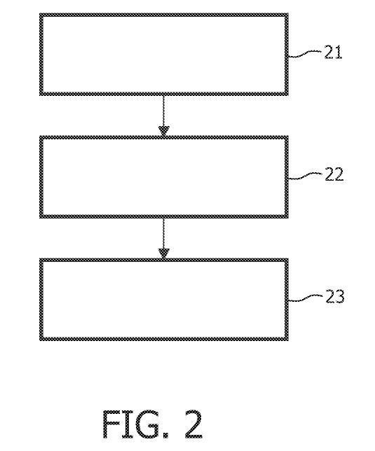

FIG. 2 illustrates a method of cleaning the refractive element of a near field optical apparatus according to one possible embodiment of the invention.

In the method illustrated, a cleaning material is used which is magnetically susceptible. This type of material is effective for removing contaminants. A first cleaning step 21 is then executed in which the cleaning material is brought into mechanical contact with the optical face of the refractive element of the near field apparatus. This cleaning step may already be sufficient to remove some of the contamination. Further cleaning may be effected by a second cleaning step 22 comprising moving the refractive element and cleaning material relative to each other. The movement assists in dislodging contamination. Finally, the refractive element can be cleaned using a conventional cleaning method or material in a third cleaning step 23 in order to remove any traces of the special magnetically susceptible cleaning material or other particulate contaminants.

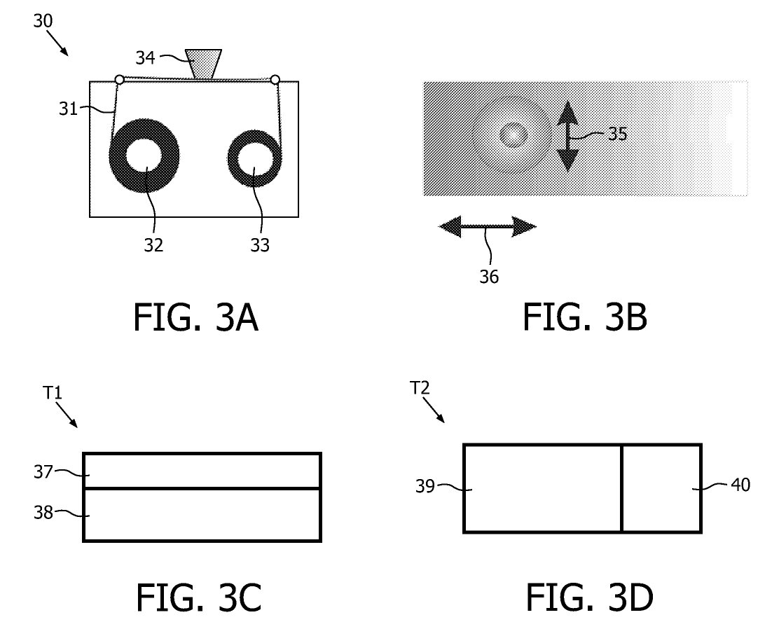

FIG. 3 illustrates one possible embodiment of a cleaning device 30 according to the invention, implementing a cleaning method according to the invention, wherein a magnetically susceptible cleaning material is attached to a flexible carrier, and the combination, in the form of a tape 31, is wound on spindles 32 and 33. The tape is transferred between the spindles 32 and 33 when the tape is set in motion. The tape 31 is brought into contact with the SIL 34 of a near field optical apparatus, not shown (FIG. 3A). In this case it is possible for the SIL 34 to be moved and for the tape 31 to be moved in combination or independently. The directions of movement are illustrated by the arrows 35 and 36 for the SIL and tape, respectively. The SIL can be moved perpendicular to the tape movement direction as shown by arrow 35. The tape can be moved back and forth as illustrated by arrow 36. Such a combination of movements is particularly advantageous as it allows cleaning of all edges of the SIL. In addition, the back-forth set of movements efficiently use the tape available so that only a small amount of tape is used for each cleaning process. A normal cassette tape can easily hold 100 meters of tape. In such a case this would be enough to sustain cleaning activities for the lifetime of the apparatus, but the tape could also be easily replaced if needed.

It is also possible for the tape to run continuously in one direction (arrow not shown). The actual pattern of movements of the tape depend on the cleaning technique chosen.

If the near field optical scanning apparatus further comprises a means for lens positioning such as a positioning means for an optical pickup unit, a 4D or 5D actuator, or a plurality of actuators, in which the SIL is mounted, it is also possible for the SIL to have a more complete range of movement than that discussed above and illustrated by arrow 35. This extended range may include tilts as well as translations in x, y and z directions.

The tape can be used to mount the cleaning material only, but it can also be desirable to mount other materials as well, such as conventional cleaning materials for final polishing of the SIL e.g. cotton/paper like materials. The tape can thus comprise parallel sections of different materials, the sections being arranged, for example, along the length of the tape with each material covering a stripe or section of width. This is shown in FIG. 3C for a first tape T1 with an example of two cleaning foils, a first cleaning foil 37 and a second cleaning foil 38, used in a two stage cleaning process. Alternatively one material may cover the whole width of the tape but the length of the tape may be split into sequential sections of different materials, as shown in FIG. 3D for a second tape T2. Here a cleaning foil according to the invention 39 is followed in the next tape section by a polishing cloth of conventional type 40. Other arrangements are also possible. The choice of sectioning the tape into different materials will depend on the application and cleaning method. The sections of tape for different materials may be the same size or they may be of different relative sizes.

It will be understood that the cleaning material according to the invention may also be applied to current apparatus cleaning devices, such as a cleaning device comprising a disc where the inner radial section of the disc is covered with conventional cleaning material, and is not restricted to tape.

### LIST OF REFERENCE NUMERALS

21 first cleaning step
22 second cleaning step
23 third cleaning step
30 cleaning device
31 tape
32 spindle
33 spindle
34 SIL (solid immersion lens)
35 Arrow indicating direction of movement of SIL
36 Arrow indicating direction of movement of tape
37 First cleaning foil
38 Second cleaning foil
39 Cleaning foil
40 Polishing cloth
T1 first tape
T2 second tape

1. A method of cleaning an optical face of a refractive element for a near field optical scanning apparatus for scanning an optical record carrier, the method comprising steps of:
A first cleaning step of bringing a magnetically susceptible cleaning material into mechanical contact with the optical face of the refractive element.

2. A method of cleaning as claimed in claim 1 wherein the cleaning material is magnetic.

3. A method of cleaning as claimed in claim 1 wherein the cleaning material comprises a floppy disc foil.

4. A method of cleaning as claimed in claim 3 wherein the floppy disc foil comprises a pattern of recording tracks.

5. A method of cleaning as claimed in claim 3 comprising a further step of:
A second cleaning step of moving the cleaning material and the optical face of the refractive element relative to each other.

6. A method of cleaning as claimed in claim 5 wherein the floppy disc foil comprises a pattern of recording tracks.

7. A method of cleaning as claimed in claim 6 further comprising the step of:
Moving the cleaning material and the optical face of the refractive element relative to each other, such that the optical face of the refractive element is drawn across the pattern of recording tracks.

8. A method of cleaning as claimed in claim 6 further comprising the step of:
Moving the cleaning material and the optical face of the refractive element relative to each other, across the pattern of recording tracks, such that the optical face of the refractive element is alternately in contact with a section of floppy disc foil comprising a recording track and a section of floppy disc foil without a recording track.

9. A method of cleaning as claimed in claim 1 comprising a further step of:
A third cleaning step of moving a conventional cleaning substance and the optical face of the refractive element relative to each other.

10. A cleaning device suitable for cleaning an optical face for a refractive element of a near field optical scanning apparatus for scanning an optical record carrier, the cleaning device comprising a cleaning material,
characterized in that,
the cleaning material is magnetically susceptible.

11. A cleaning device as claimed in claim 10, wherein the cleaning material is magnetic.

12. A cleaning device as claimed in claim 10, wherein the cleaning material comprises a floppy disc foil.

13. A cleaning device as claimed in claim 12, wherein the floppy disc foil comprises a pattern of recording tracks.

14. A cleaning device as claimed in claim 10, wherein the cleaning material is mounted on a flexible carrier.

15. A cleaning device as claimed in claim 14, wherein the cleaning device further comprises a cleaning tape, at least one section of which comprises the cleaning material.

16. Use of a floppy disc foil for cleaning an optical face of a refractive element.
